(19) United States
(12) Patent Application Publication
(10) Pub. No.: US 2013/0207625 A1
(43) Pub. Date: Aug. 15, 2013

(54) SWITCHING REGULATOR

(71) Applicant: Fujitsu Semiconductor Limited, (US)

(72) Inventor: Kazuyoshi FUTAMURA, Yokohama (JP)

(73) Assignee: Fujitsu Semiconductor Limited, Yokohama-shi (JP)

(21) Appl. No.: 13/692,761

(22) Filed: Dec. 3, 2012

(30) Foreign Application Priority Data
Feb. 9, 2012 (JP) 2012-025669

(51) Int. Cl. G05F 1/10

(52) U.S. Cl. CPC G05F 1/10
USPC 323/271; 323/283

(57) ABSTRACT

A switching regulator controls an output transistor supplying current to an inductor and generates a second supply voltage from a first supply voltage. The switching regulator has: an error amplifier amplifying a difference between the second supply voltage and a reference voltage; a current sense amplifier converting an inductor current into voltage; a current comparator comparing an output voltages of the error amplifier and the current sense amplifier, so as to output a trigger signal when the second supply voltage decreases; a pulse generation circuit generating a control pulse to drive the first output transistor in response to the trigger signal; and a sleep control circuit, during a sleep period by a sleep signal supplied from a load side, suspending operation of the current sense amplifier or the pulse generation circuit, and tentatively resuming the suspended operation in response to the trigger signal, and thereafter suspending the operation again.

### CROSS-REFERENCE TO RELATED APPLICATION

This application is based upon and claims the benefit of priority of the prior Japanese Patent Application No. 2012-025669, filed on Feb. 9, 2012, the entire contents of which are incorporated herein by reference.

### FIELD

The embodiment relates to a switching regulator.

### BACKGROUND

A switching regulator generates from an input first supply voltage a second supply voltage to be supplied to a load circuit, and supplies the generated voltage thereto. The switching regulator is intended to maintain the second supply voltage to a specified voltage in both a heavy load condition in which a large current is consumed in the load circuit and a light load condition in which a small current is consumed.

In another aspect, from a demand of low power consumption in the switching regulator mounted on, for example, mobile equipment or the like, it is preferable to suppress power consumption in the internal circuit of the switching regulator, so as to improve power conversion efficiency.

A variety of losses are included in the power loss of the switching regulator. For example, the losses include an inductor current loss and an inductor hysteresis loss, as well as switching loss, conduction loss and gate charge loss in an output drive transistor. To improve power conversion efficiency, there is a need to reduce such losses to the minimum to a possible extent.

As to the switching regulator, disclosure has been made in the following patent documents. According to these patent documents, it is controlled to reduce power consumption when the load in the load circuit is light, by switching over to a drive by a standby FET having a small gate width, and according to the degree of load in the load circuit, to control the number of output drive transistors, for example, by reducing the number of output drive transistors as the load becomes smaller, so as to suppress the gate charge loss.

The patent documents are U.S. Pat. No. 5,731,731, U.S. Pat. No. 5,969,514.

As such, in the conventional switching regulator in which, by the monitoring of an output current etc., when a light load condition is detected, the output drive transistors are switched or reduced in number. However, the most portions of incorporated control circuits have to be kept in an operating state so as to prepare for a sudden change of a load condition in the load circuit. Therefore, improvement in efficiency may be insufficient in the conventional switching regulator.

### SUMMARY

According to a first aspect of the embodiment, a switching regulator which controls a first output transistor supplying current to an inductor and generates a second supply voltage from a first supply voltage, the switching regulator has: an error amplifier configured to amplify a difference between the second supply voltage and a first reference voltage; a current sense amplifier configured to convert an inductor current flowing through the inductor into voltage; a current comparator configured to compare an output voltage of the error amplifier with an output voltage of the current sense amplifier, so as to output a trigger signal when the second supply voltage decreases; a pulse generation circuit configured to generate a control pulse to drive the first output transistor in response to the trigger signal; and a sleep control circuit configured to, during a sleep period by a sleep signal supplied from a load side to which the second supply voltage is supplied, suspend operation of the current sense amplifier or the pulse generation circuit, and to tentatively resume the suspended operation of the current sense amplifier or the pulse generation circuit in response to the trigger signal, and thereafter to suspend the operation again, wherein in the sleep period, the pulse generation circuit generates the control pulse after a lapse of a prescribed time after the occurrence of the trigger signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating the configuration of a switching regulator.

FIG. 2 is a waveform diagram illustrating the operation of the switching regulator depicted in FIG. 1.

FIG. 3 is a waveform diagram illustrating the operation of the switching regulator depicted in FIG. 1.

FIG. 4 is the configuration diagram of a switching regulator according to a first embodiment.

FIG. 5 is a configuration diagram of the sleep control circuit 30.

FIG. 6 is a configuration diagram of the timing circuit 32.

FIG. 7 is a timing chart illustrating the operation of the switching regulator.

FIG. 8 is the configuration diagram of a switching regulator according to a second embodiment.

FIG. 9 is a timing chart illustrating the operation of the switching regulator depicted in FIG. 8.

FIG. 10 is the configuration diagram of a switching regulator according to a third embodiment.

FIG. 11 illustrates circuit diagrams of the current comparators 14-1, 14-2, respectively.

FIG. 12 is a timing chart illustrating the operation of the switching regulator depicted in FIG. 10.

FIG. 13 is the configuration diagram of a switching regulator according to a fourth embodiment.

FIG. 14 is the configuration diagram of a switching regulator according to a fifth embodiment.

### DESCRIPTION OF EMBODIMENTS

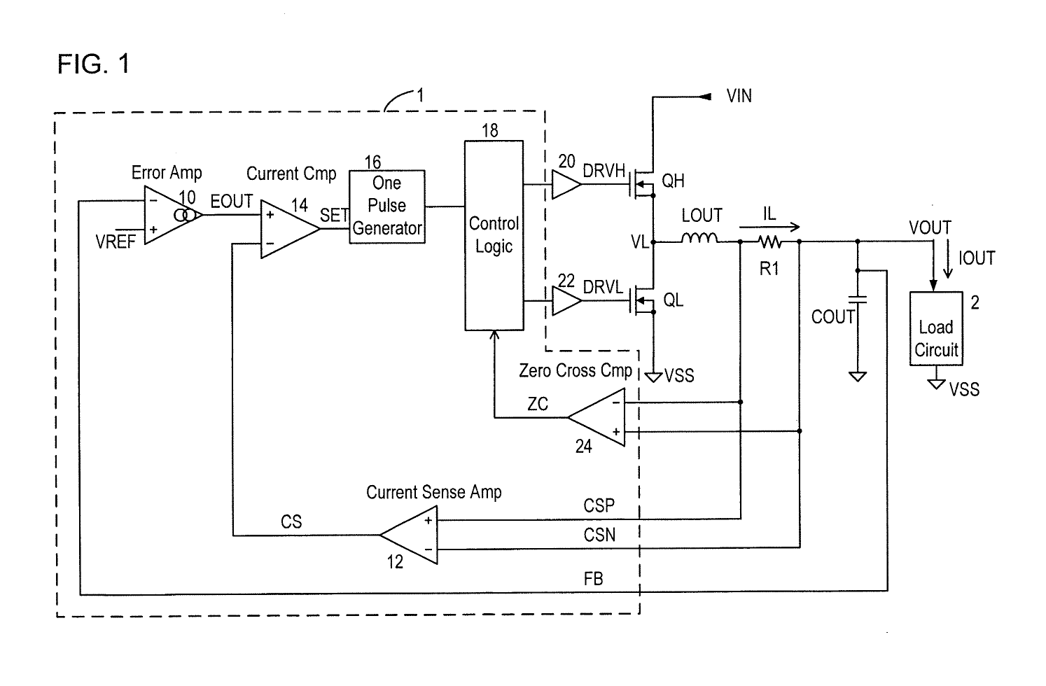

FIG. 1 is a diagram illustrating the configuration of a switching regulator. The switching regulator is a circuit to generate, from a first supply voltage VIN input thereto, a second supply voltage VOUT to be supplied to a load circuit 2. In the configuration, the switching regulator includes a first output transistor QH and a second output transistor QL which are disposed between the first supply voltage VIN and a ground VSS, a reference voltage. The switching regulator further includes: an inductor (coil) LOUT disposed between a connection node VL of the above output transistors and an output terminal (a node of the second supply voltage VOUT); a capacitor (condenser) COUT disposed at the output terminal; and a control unit 1 which controls to drive the output transistors QH, QL.

The control unit 1 enclosed by broken lines in FIG. 1 is formed in one integrated circuit chip, and constitutes the switching regulator together with the externally mounted first and second output transistors QH, QL, driver circuits 20, 22 generating drive signals DRVH, DRVL therefor and the inductor LOUT. Or, there may be cases that the switching regulator is constituted by an integrated circuit chip alone which incorporates the control unit 1 and the entire or a portion of the first and second output transistors QH, QL and the driver circuits 20, 22 which generate the drive signals DRVH, DRVL therefor and the inductor LOUT.

Therefore, according to the present embodiment, in some cases the switching regulator signifies only the control unit 1 enclosed by the broken lines in FIG. 1, or in other cases, signifies a configuration including the control unit 1, the first and second output transistors QH, QL and the driver circuits 20, 22 which generate the drive signals DRVH, DRVL therefor and the inductor LOUT. In the former cases, the control unit 1 is designated as a switching regulator 1.

The switching regulator 1 includes: an error amplifier 10 which amplifies a difference between the second supply voltage VOUT which is negatively fed back and the reference voltage VREF; a current sense amplifier 12 which converts an inductor current IL into a voltage by amplifying the voltage drop of a resistor element R1 caused by the inductor current; and a current comparator 14 which compares an output voltage EOUT of the error amplifier 10 with an output voltage CS of the current sense amplifier 12, and outputs a trigger signal SET when the output voltage EOUT exceeds the output voltage CS due to decreased potential of the second supply voltage VOUT.

In response to the trigger signal SET output from the current comparator 14, a drive control circuit 18 outputs drive pulses DRVH, DRVL to control the output transistors QH, QL through the driver circuits 20, 22, based on a pulse output from a one pulse generation circuit 16. In short, the one pulse generation circuit 16 and the drive control circuit 18 constitute a pulse generation circuit for generating control pulses to drive the output transistors.

The two output transistors QH, QL repeat conducting and non-conducting in response to the above drive pulses DRVH, DRVL, and supply a substantially constant output current IOUT to the load circuit 2 using a smoothing function of an LC circuit constituted by the inductor LOUT and the capacitor COUT. Further, the second supply voltage VOUT to be supplied to the load circuit 2 is maintained to a desired voltage level the load circuit 2 demands.

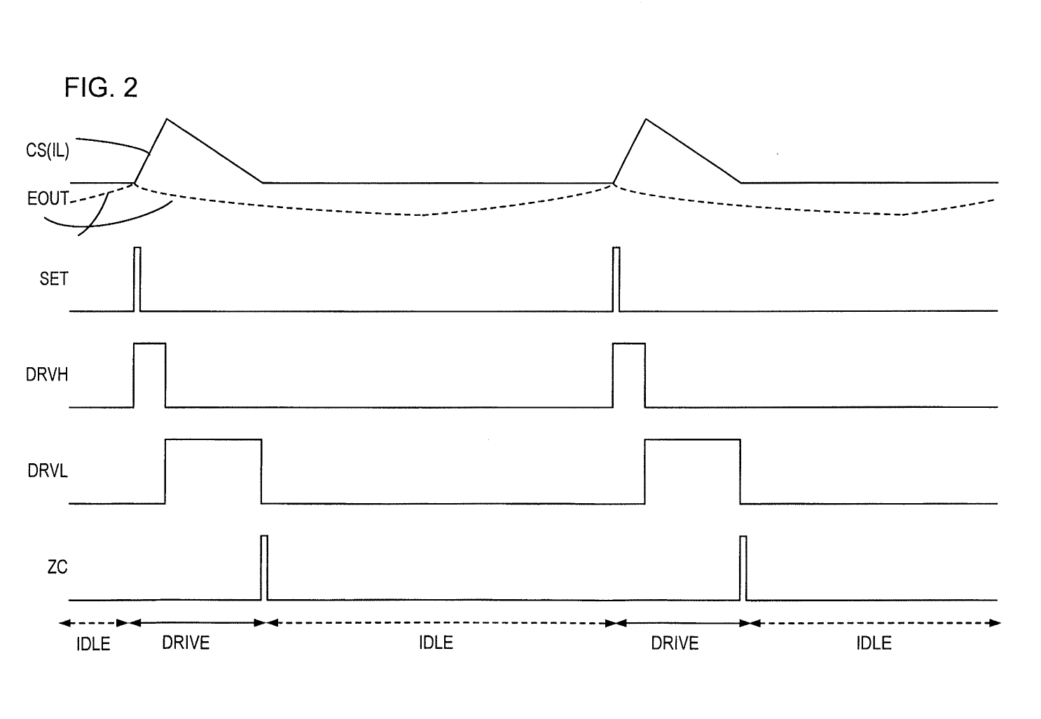

FIG. 2 is a waveform diagram illustrating the operation of the switching regulator depicted in FIG. 1. FIG. 2 illustrates operation waveforms when the load circuit 2 is in a light load condition and the consumed current IOUT is small because of high internal resistance of the load circuit. First, the second supply voltage VOUT is negatively fed back to the error amplifier 10, and if the second supply voltage VOUT decreases relative to the reference voltage VREF, the output voltage EOUT increases, and to the contrary, if the second supply voltage VOUT increases to approach the reference voltage VREF, the output voltage EOUT decreases. In a state of no current supply from the first output transistor QH, the inductor current IL is zero, and the output voltage CS of the current sense amplifier 12 is a voltage corresponding to the zero current. In the above state, if the second supply voltage VOUT decreases by the reduction of charge in the output capacitor COUT due to current consumption in the load circuit 2, the output voltage EOUT of the error amplifier 10 increases.

When the output voltage EOUT increases to reach the output voltage CS, the current comparator 14 outputs the trigger signal SET. In response to the trigger signal SET, the one pulse generation circuit 16 generates a control pulse having a prescribed pulse width (a constant pulse width, for example). Then, the drive control circuit 18 outputs a first drive pulse DRVH (an H-level pulse) having a pulse width corresponding to the control pulse thereof, so as to render the first transistor QH conductive. By the conduction of the first transistor QH, the voltage of the connection node VL increases to the first supply voltage VIN, and also the inductor current IL of the inductor LOUT increases.

The drive control circuit 18 outputs a second drive pulse DRVL (an H-level pulse) in place of the first drive pulse DRVH, so as to render the first output transistor QH non-conductive and the second output transistor QL conductive. By this, current supply to the inductor LOUT from the first supply voltage VIN through the first output transistor QH is suspended, and however, because of the conduction of the second output transistor QL, a forward current in an arrow direction depicted in FIG. 1 continues to flow through the inductor LOUT by electromagnetic energy stored therein. However, the inductor current IL gradually decreases.

A zero-cross comparator 24, on detecting that the inductor current IL becomes zero, outputs a zero-cross detection signal ZC. In response thereto, the drive control circuit 18 sets the second drive pulse DRVL to the L level. By this, it is prevented that the inductor current IL flows to the reverse direction, and a charge in the output capacitor COUT is discarded to the ground VSS through the output transistor QL.

In FIG. 2, during a time period (drive period DRIVE) from the trigger signal SET to the zero-cross detection signal ZC, current supply operation to the second power supply VOUT is performed. By this current supply, the output voltage VOUT increases and the output voltage EOUT of the error amplifier 10 decreases, and thus an idle period IDLE during which no current is supplied is produced.

As such, in a light load case, the drive period DRIVE and the idle period IDLE are repeated, and a relatively small current IOUT is supplied to the load circuit 2, and the second supply voltage VOUT is maintained to a desired voltage level.

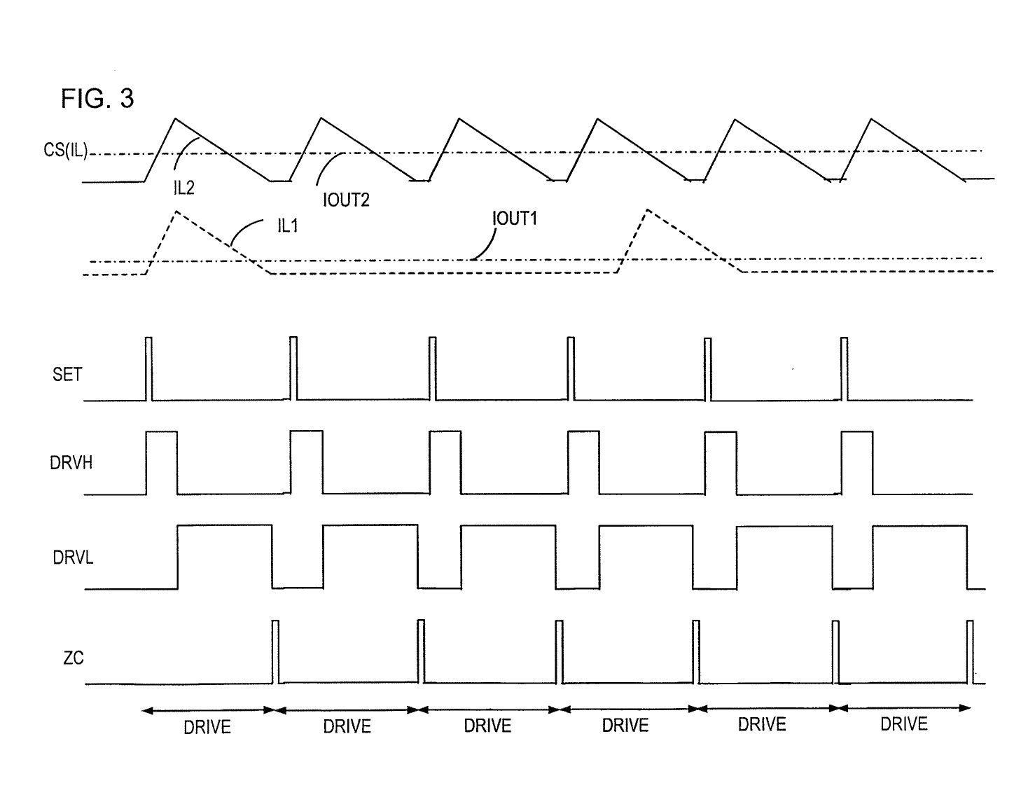

FIG. 3 is a waveform diagram illustrating the operation of the switching regulator depicted in FIG. 1. FIG. 3 illustrates operation waveforms when the load circuit 2 is in a heavier load condition than in FIG. 2, producing a state that a large output current IOUT is consumed because of a low internal resistance of the load circuit. In FIG. 3, in regard to the current sense amplifier output CS, there are depicted solid lines which indicates a heavy load condition and broken lines which indicates a light load condition.

In the heavy load condition, there is large current consumption in the load circuit 2, and the voltage of the second supply voltage VOUT immediately decreases after current drive is made, so as to immediately produce a high output voltage EOUT of the error amplifier 10. Accordingly, current supply operation in the drive period DRIVE depicted in FIG. 2 is repeated without passing through the idle period IDLE. Because of large current consumption by the load circuit 2 in the heavy load condition, an inductor current IL2 in the heavy load condition is maintained to be a higher level than an inductor current IL1 in the light load condition (broken lines).

In the switching regulator depicted in FIG. 1, a transfer function includes a double pole because of an LC resonance circuit including the inductor LOUT and the capacitor COUT, so that a phase advances 360°. A phase compensation circuit to compensate the phase produced by the double pole is complicated and difficult to implement. Therefore, by the feedback of the inductor current IL to the input side of the control unit 1 with the provision of the current sense amplifier 12, the resonance point of the LC resonance circuit is made unseen. As a result, the transfer function includes only a unipole of a CR circuit configured by the capacitor COUT and the internal resistance of the load circuit 2, so that the phase compensation circuit may be simplified.

The aforementioned switching regulator has the problem of poor power efficiency in a light load condition. More specifically, in preparation of an abrupt load variation, particularly a sudden increase of the load, even when the load circuit 2 is in the light load condition, the switching regulator is configured to supply ordinary bias currents to the error amplifier 10, the current sense amplifier 12 and the current comparator 14, so as to enable fast response to a sudden change of the load. Similarly, an ordinary bias current is supplied to a portion of circuits in the one pulse generation circuit 16. Therefore, in the light load condition, bias currents similar to the case of a heavy load condition are consumed because the bias currents are continuously supplied to the above-mentioned circuits in preparation to the sudden change of the load, though the frequency of the drive period DRIVE is reduced. By this, undesirably the overall power efficiency is decreased.

### First Embodiment

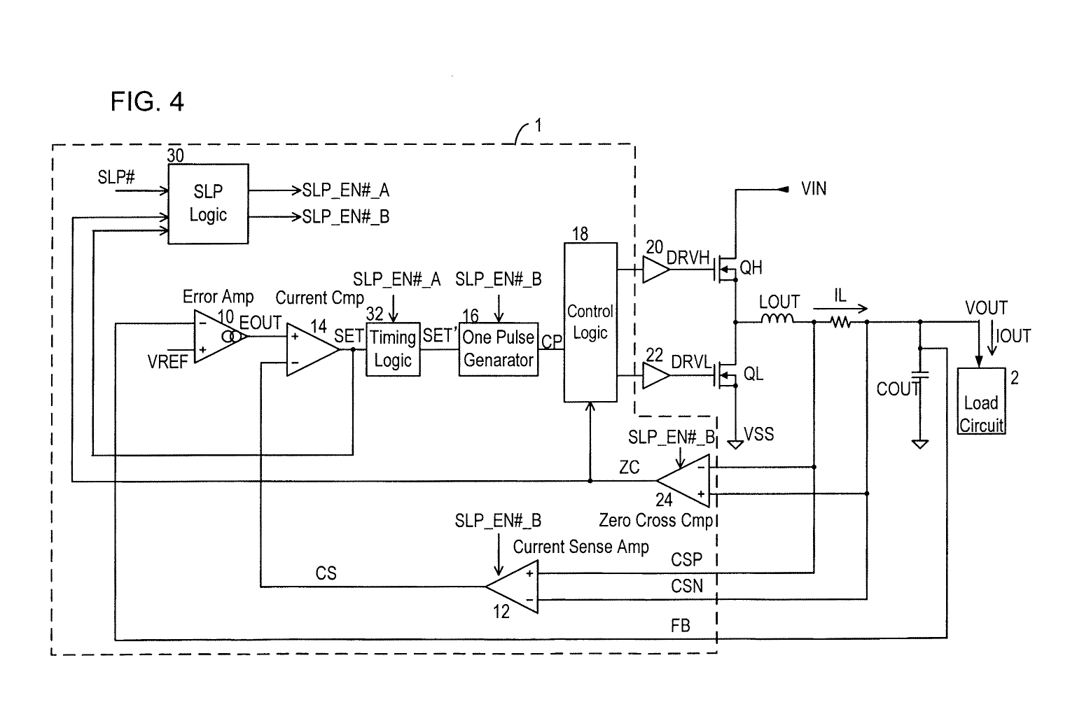

FIG. 4 is the configuration diagram of a switching regulator according to a first embodiment. The switching regulator stop or suspends the operation of a current sense amplifier 12 and a one pulse generation circuit 16 which generates a pulse CP is suspended (or minimizes the bias currents), when a sleep signal SLP# (where # signifies that an active state is produced when the signal of concern is in the L level), which guarantees a small load current and no occurrence of a sudden change in the load current, is received from either a load circuit 2 to which a second supply voltage VOUT is supplied or a control unit which controls the load circuit 2 (both together are designated as a load system). Here, an error amplifier 10 and a current comparator 14 are maintained to be in operational states, and further, when detecting a decrease of the second supply voltage VOUT supplied to the load circuit 2, the current sense amplifier 12 and the one pulse generation circuit 16 whose operation has been suspended are initiated to resume the operation, so as to drive output transistors QH, QL and start supplying current to the second supply voltage VOUT side. On completion of a drive period, the operation of the current sense amplifier 12 and the one pulse generation circuit 16 is suspended again. Such an operation suspension is performed by, for example, intercepting bias currents.

To initiate the current sense amplifier 12 and the one pulse generation circuit 16 to resume the operation, a prescribed time is needed.

Therefore, once the operation is suspended as described above, it is not possible to fast respond to a sudden load variation. However, when the sleep signal SLP# guaranteeing no occurrence of a sudden load change is received from the load system side, such a fast response to the load variation may be unnecessary, and therefore, no problem is produced by the operation suspension of the current sense amplifier 12 and the one pulse generation circuit 16 as described above.

In addition to the configuration depicted in FIG. 1, the switching regulator depicted in FIG. 4 further includes: in response to the sleep signal SLP# supplied from the load system, a sleep control circuit 30 for generating sleep enable signals SLP_EN#_A, SLP_EN#_B; and a timing circuit 32 for delaying a trigger signal SET by a prescribed time, to supply a delayed trigger signal SET′ to the one pulse generation circuit 16. In an ordinary operating state, based on the sleep enable signal SLP_EN#_A, the timing circuit 32 supplies the trigger signal SET to the one pulse generation circuit 16 without delaying the trigger signal SET. When it becomes a sleep period by receiving the sleep signal SLP#, the timing circuit 32 delays the trigger signal SET.

On receiving the sleep signal SLP#, the sleep control circuit 30 renders both sleep enable signals SLP_EN#_A, SLP_EN#_B active (L level), in response to a zero-cross detection signal ZC. As a result, by means of the SLP_EN#_A in the L level, the sleep control circuit 30 allows the timing circuit 32 to perform delay operation, and by means of the SLP_EN#_B in the L level, the sleep control circuit 30 allows the current sense amplifier 12, the one pulse generation circuit 16 and the zero-cross comparator 24 to suspend the operation thereof (or suppress the bias currents). More specifically, the sleep control circuit 30 intercepts the bias currents of the current sense amplifier 12, the one pulse generation circuit 16 and the zero-cross comparator 24, to disable the operation thereof.

In the above state, when the trigger signal SET is generated by the error amplifier 10 and the current comparator 14 accompanying the decrease of the output voltage VOUT, the sleep control circuit 30 renders the sleep enable signal SLP_EN#_B a non-active state (H level), so as to initiate the current sense amplifier 12, the one pulse generation circuit 16 and the zero-cross comparator 24 whose operation has been suspended. Because a prescribed time is to be consumed to initiate the above circuits, the timing circuit 32 delays the trigger signal SET corresponding to the above time, so as to output the delayed trigger signal SET′ to the one pulse generation circuit 16. Before the supply of the delayed trigger signal SET, the one pulse generation circuit 16, the current sense amplifier 12 and the zero-cross comparator 24 have completed the initiation thereof to become operating states, and current supply operation from the inductor LOUT is executed accordingly.

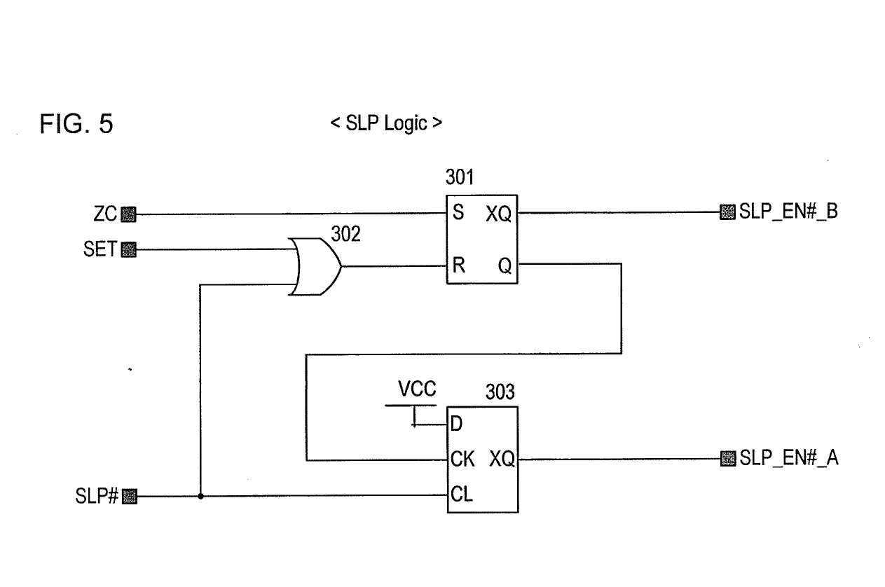

FIG. 5 is a configuration diagram of the sleep control circuit 30. The sleep control circuit 30 includes flip-flops 301, 303 and an OR gate 302.

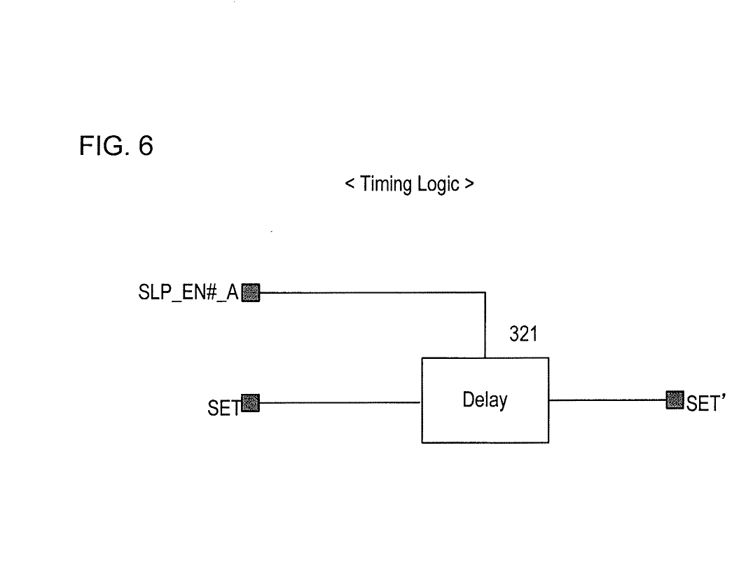

FIG. 6 is a configuration diagram of the timing circuit 32. When the sleep enable signal SLP_EN#_A is active (L level), the timing circuit 32 outputs the delayed trigger signal SET′ by delaying the trigger signal SET, while when the sleep enable signal SLP_EN#_A is inactive (H level), the timing circuit 32 does not delay the trigger signal SET.

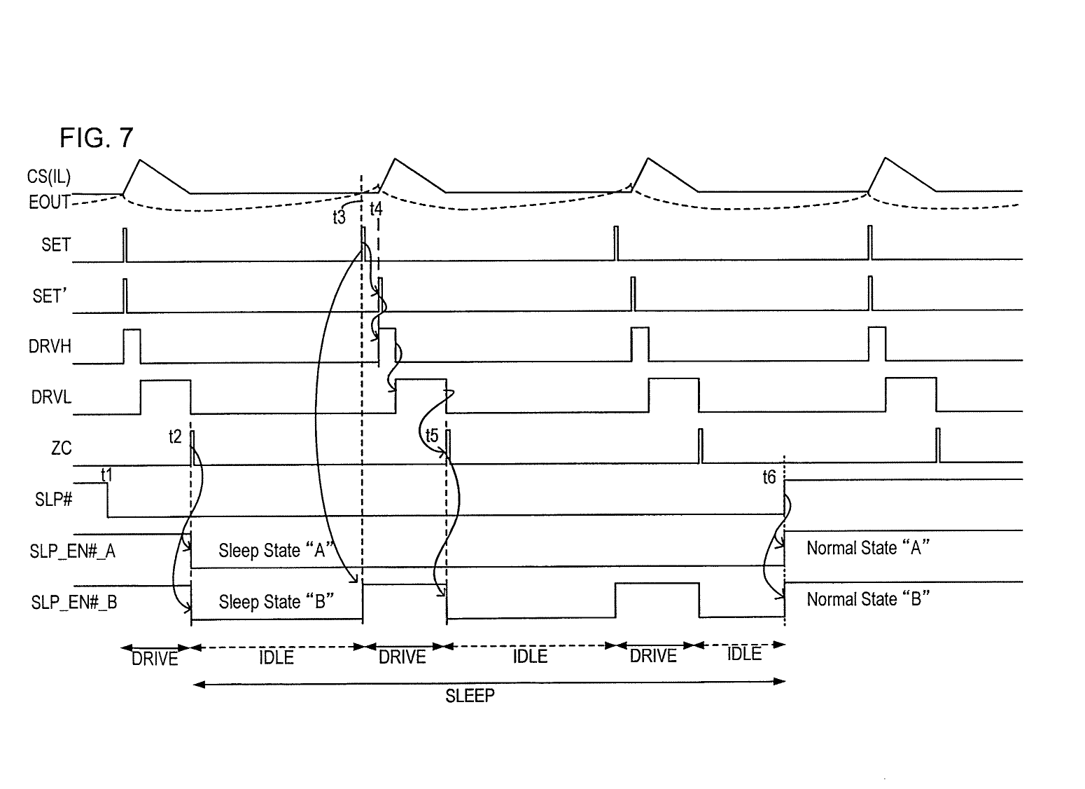

FIG. 7 is a timing chart illustrating the operation of the switching regulator. By reference to FIG. 7, the operation of the switching regulator is explained along with the operation of the sleep control circuit.

First, when the sleep signal SLP# is inactive (H level), because of SET=L and ZC=L, the flip-flop 301 is reset so that the inverted output XQ thereof is set to the H level, and the flip-flop 303 is cleared so that the inverted output XQ thereof is set to the H level, so that both sleep enable signals SLP_EN#_A, SLP_EN#_B are made inactive (H level). At a time t1, when the sleep signal SLP# becomes active (L level), the reset state of the flip-flop 301 is canceled, and also the clear state of the flip-flop 303 is canceled. However, the states of both sleep enable signals are not changed.

Therefore, even if the sleep signal SLP# becomes active (L level), the bias currents of the current sense amplifier 12, the one pulse generation circuit 16 and the zero-cross comparator 24 are not intercepted immediately, so that ordinary operation is continued.

In FIG. 7, in response to the trigger signal SET after the time t1, the trigger signal SET′ is output without a delay, and the one pulse generation circuit 16 generates the pulse CP, and the drive control circuit sequentially generates the drive pulses DRVH, DRVL, so as to sequentially render the output transistors QH, QL conductive, and thereby current supply operation is performed through the inductor LOUT. Further, the zero-cross comparator 24 detects the inductor current IL is changed from the forward direction to the backward direction, and output the zero-cross detection signal ZC. As such, the drive operation DRIVE explained in FIGS. 1, 2 is carried out.

Next, at a time t2, when the inductor current IL becomes zero and the zero-cross detection signal ZC becomes the H level (ZC=H), a sleep period corresponding to the sleep signal SLP# is started. More specifically, the flip-flop 301 in the sleep control circuit 30 is set, so that the outputs thereof become Q=H and XQ=L, respectively. In synchronization with the above Q=H, the flip-flop 303 fetches an H-level data D, so that the output thereof becomes XQ=L. By this, both sleep enable signals SLP_EN#_A, SLP_EN#_B become active (L level). This intercepts the bias currents in the current sense amplifier 12, the one pulse generation circuit 16 and the zero-cross comparator 24, so as to suspend the operation thereof, and thus, the timing circuit 32 becomes a delay operation state. By this, power consumption caused by the bias currents in the current sense amplifier 12, the one pulse generation circuit 16 and the zero-cross comparator 24 is eliminated, and the idle period IDLE is started. During the operation of suspension of the current sense amplifier 12, the output voltage CS thereof is zero.

During the idle period IDLE, at a time t3, when the potential of the second supply voltage VOUT decreases due to the current consumption in the load circuit 2, the output voltage EOUT of the error amplifier 10 increases, and when it exceeds the output voltage CS of the current sense amplifier 12, the current comparator 14 outputs the trigger signal SET. In response to this trigger signal SET (=H level), the flip-flop 301 in the sleep control circuit 30 is reset, so that the outputs become XQ=H and Q=L, respectively, and the sleep enable signal SLP_EN#_B becomes inactive (H level). Here, the other sleep enable signal SLP_EN#_A is maintained to be active (L level).

In response to the inactive state (H level) of the sleep enable signal SLP_EN#_B at the time t3, the bias currents of the current sense amplifier 12, the one pulse generation circuit 16 and the zero-cross comparator 24 are resumed, so that their operation is resumed after initiation operation. Here, a prescribed time is to be consumed in the above initiation operation. On the other hand, the timing circuit 32 delays the trigger signal SET, and at a time t4, outputs the delayed trigger signal SET′ to the one pulse generation circuit 16. At this time point, the initiation operation of the one pulse generation circuit 16 etc. has already been completed. As a result, the time t4 and thereafter become the drive period DRIVE to sequentially render the output transistors QH, QL conductive, so that current supply to the second power supply VOUT is performed. As a result, the potential of the second supply voltage VOUT increases, and the output voltage EOUT of the error amplifier 10 decreases.

At a time t5, when the zero-cross detection signal ZC becomes the H level (ZC=H), similar to the time t2, the flip-flop 301 in the sleep control circuit 30 is set, so that the output becomes XQ=L to render the sleep enable signal SLP_EN#_B active (L level). In response thereto, the bias currents of the current sense amplifier 12, the one pulse generation circuit 16 and the zero-cross comparator 24 are intercepted again and their operation is suspended, and thus the idle period IDLE is started.

In the above-mentioned manner, during the sleep period in which the sleep signal SLP# is in the active state (L level), the drive period DRIVE and the idle period IDLE are repeated alternately. In particular, because the bias currents of the current sense amplifier 12, the one pulse generation circuit 16 and the zero-cross comparator 24 are intercepted in the idle period IDLE, it is possible to suppress a power loss.

Thereafter, at a time t6, when the sleep signal SLP# becomes inactive (H level), each flip-flop in the sleep control circuit 30 is reset or cleared, to render both sleep enable signals SLP_EN#_A, SLP_EN#_B inactive (H level), so that the switching controller starts ordinary operation. In this ordinary operating state, because the current sense amplifier 12, the one pulse generation circuit 16 and the zero-cross comparator 24 are in operating states, it is possible for the switching controller to fast respond to a load variation, enabling coping with a sudden load change.

In FIG. 4, the LSI chip 1 of the switching regulator does not incorporate the drive circuits 20, 22, the output transistors QH, QL and the inductor LOUT. However, it may also be possible to incorporate the entire or a portion thereof.

### Second Embodiment

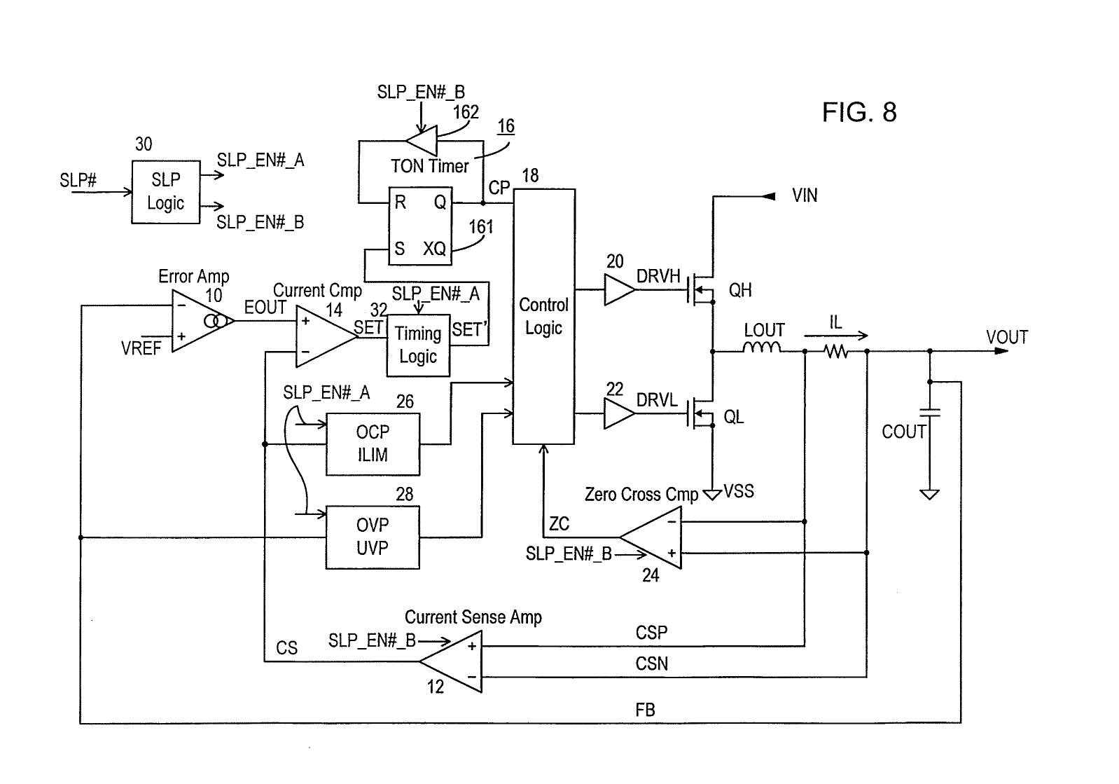

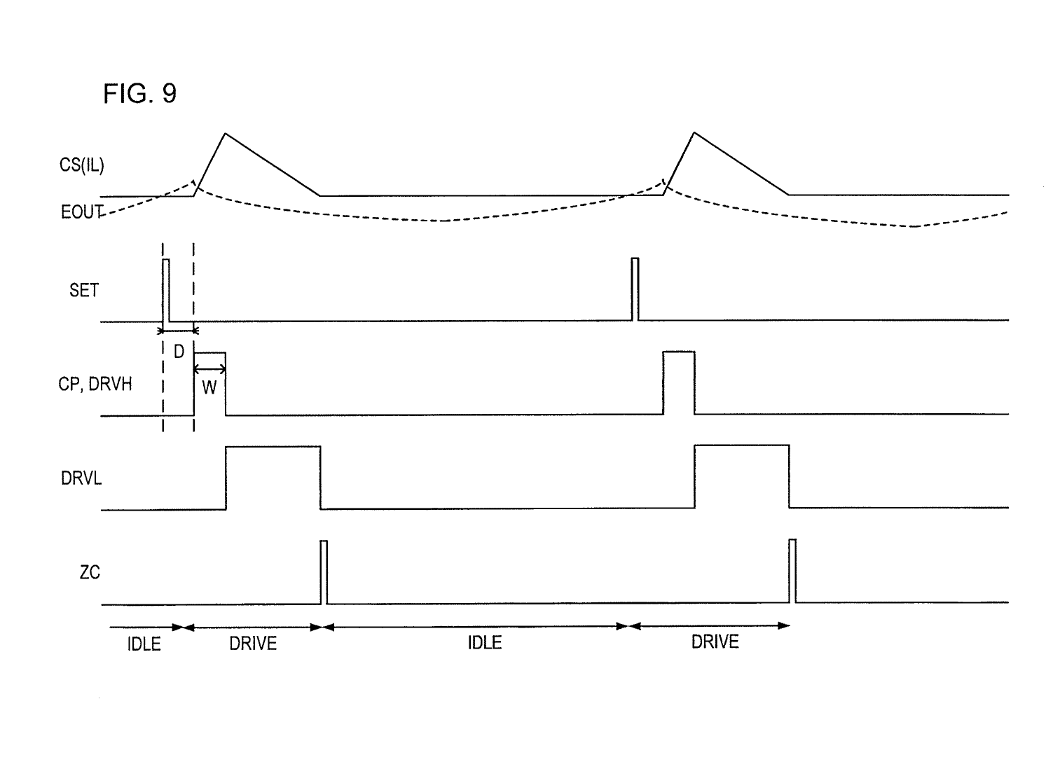

FIG. 8 is the configuration diagram of a switching regulator according to a second embodiment. FIG. 9 is a timing chart illustrating the operation of the switching regulator depicted in FIG. 8. In FIG. 8, a point of difference in configuration from the first embodiment depicted in FIG. 4 is that there are provided an ON-time timer circuit having a flip-flop 161 and a timer circuit 162 as the one pulse generation circuit 16, and further, an overcurrent protection circuit 26 and an overvoltage & undervoltage protection circuit 28. Other configuration is identical to the configuration depicted in FIG. 4. Here, the LSI chip 1 in the switching regulator is omitted in FIG. 8.

In the one pulse generation circuit 16, the flip-flop 161 is set in response to the trigger signal SET or SET′, so as to set the output Q to the H level. After a constant time W from the rise edge of the output Q, the timer circuit 162 sets an output to the H level, and in response thereto, the flip-flop 161 is reset, so that the output Q is set to the L level. Accordingly, a pulse width W of the pulse CP in the output Q of the flip-flop 161 becomes constant.

The drive control circuit 18 then generates the drive pulse signal DRVH of an identical pulse width to the pulse CP, so as to render the first output transistor QH conductive for a time period equal to the pulse width W. Further, after setting the drive pulse signal DRVH to the L level, the drive control circuit 18 outputs the other drive pulse signal DRVL (H level) to render the second output transistor QL conductive. Thereafter, the drive control circuit 18 sets the drive pulse signal DRVL to the L level in response to the rise to the H level of the zero-cross detection signal ZC which is output from the zero-cross comparator 24 when the inductor current IL, which flows through the inductor LOUT in the forward direction from the ground VSS through the second output transistor QL, becomes zero.

As such, in the switching regulator according to the second embodiment, it may be understood that the pulse width of the drive pulse DRVH of the first output transistor QH has the constant value W, and according to the load condition of the load circuit, PFM control to vary a frequency in the drive period during which current is supplied is carried out.

When the output voltage CS of the current sense amplifier 12 exceeds an allowance, the overcurrent protection circuit 26 allows the drive control circuit 18 to set both the drive pulse signals DRVH, DRVL to the L level, so as to suspend the drive operation of the output transistors QH, QL. By this, an excessive current flow in the inductor LOUT is prevented. An exemplary case of such an excessive current flow is that the second power supply VOUT and the ground are short-circuited in the load circuit 2. In such a case, the overcurrent protection circuit 26 avoids excessive current flow in the load circuit 2 and the inductor LOUT.

The overvoltage & undervoltage protection circuit 28, on detecting that the voltage level of the second supply voltage VOUT, which is to be fed back by a feedback loop FB, excessively increases above an upper limit value or excessively decreases below a lower limit value, allows the drive control circuit 18 to set both drive pulse signals DRVH, DRVL to the L level, so as to suspend the drive operation of the output transistors QH, QL. By this, the second supply voltage VOUT is maintained within a voltage range between the upper limit value and the lower limit value.

According to the present embodiment, when the sleep enable signal SLP_EN#_A becomes active (L level), the overcurrent protection circuit 26 and the overvoltage & undervoltage protection circuit 28 prevent current consumption by suspending operation during the sleep period. Because these circuits 26, 28 are protection circuits which are desired only in an unexpected situation, there is small necessity to be operated particularly during the sleep period when the sleep signal SLP# from the load system side is active (L level). Therefore, by suspending the operation to suppress current consumption during the sleep period, it is possible to contribute to the improvement of power efficiency. Alternatively, it may also be possible to suspend the operation of the circuits 26, 28 only during an idle period in which the sleep enable signal SLP_EN#_B is active (L level) during the sleep period.

The timing chart depicted in FIG. 9 illustrates operation during the sleep period when the sleep signal SLP# is active (L level). Similar to the foregoing description, when the trigger signal SET is generated by a decreased second supply voltage VOUT during the sleep period, by the non-illustrated sleep enable signal SLP_EN#_B rendered inactive (H level), the bias currents of the current sense amplifier 12, the one pulse generation circuit 16 and the zero-cross comparator 24 are resumed to perform initiation operation, and thus the operation of these circuits is resumed. Further, in response to the delayed trigger signal SET′ which is input after a prescribed delay time, the one pulse generation circuit 16 outputs the pulse CP of the constant pulse width W. The drive control circuit 18 then outputs the drive pulse signal DRVH of an identical pulse width to the pulse CP, to render the first output transistor QH conductive. Thereafter, after rendering the first output transistor QH non-conductive, the drive control circuit 18 outputs the drive pulse signal DRVL to render the second output transistor QL conductive, and further, in response to the zero-cross detection signal ZC thereafter, sets the drive pulse signal DRVL to the L level, so as to render the second output transistor QL non-conductive.

A delay time D depicted in FIG. 9 is set larger than and including a time needed to initiate the current sense amplifier 12, the one pulse generation circuit 16 and the zero-cross comparator 24. Further, the pulse width W is the pulse width of the pulse CP and the drive pulse DRVH, which is constant.

### Third Embodiment

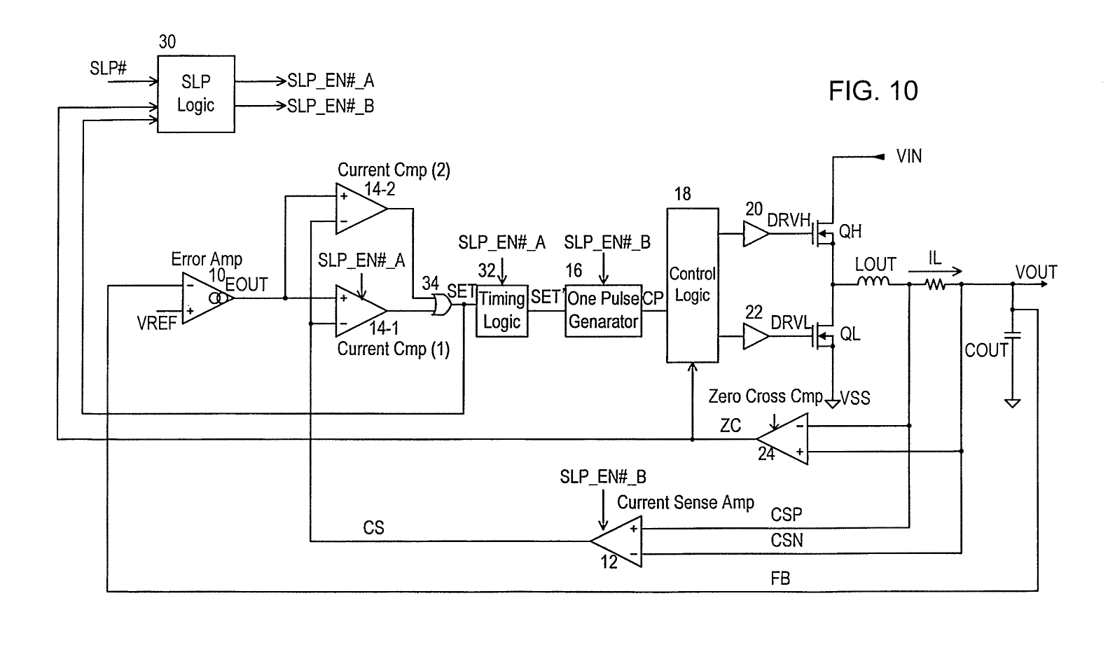

FIG. 10 is the configuration diagram of a switching regulator according to a third embodiment. In FIG. 10, the LSI chip 1 of the switching regulator is omitted. In FIG. 10, a point of difference in configuration from FIG. 4 is that the current comparator includes two current comparators 14-1, 14-2. A first current comparator 14-1 is a circuit capable of fast responding to an input variation, while a second current comparator 14-2 is a circuit with a slower response speed than the first current comparator 14-1.

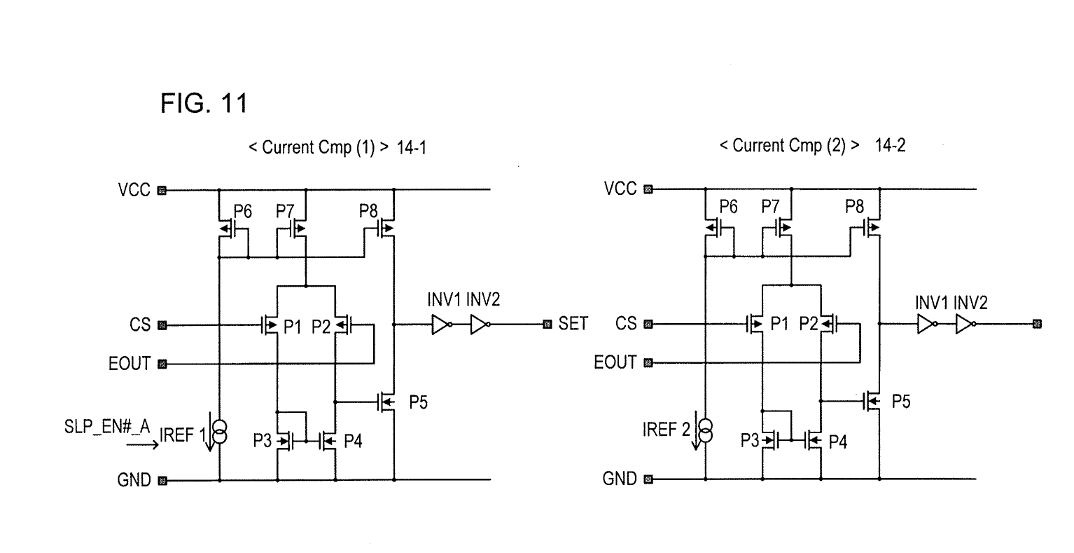

FIG. 11 illustrates circuit diagrams of the current comparators 14-1, 14-2, respectively. The two circuits are of equivalent configuration, each including: PMOS transistors P1, P2 which compare the output voltage EOUT with CS; PMOS transistors P3, P4 connected as the loads of the PMOS transistors P1, P2; and an output PMOS transistor P5 whose gate is connected to the drain terminal of the PMOS transistor P2. Further, each current comparator includes: a bias current source IREF; PMOS transistors P6, P7, P8 constituting a current mirror circuit to distribute the bias current from the bias current source IREF; and two-stage inverters INV1, INV2 disposed on the output side.

A current of a bias current source IREF1 of the first current comparator 14-1 of fast response produces a current flow, for example, ten times larger than a bias current source IREF2 of the second current comparator 14-2 of slow response. Though the first current comparator 14-1 produces larger current consumption due to the larger bias current, it is possible to output a trigger signal SET in fast response to the variation of inputs EOUT and CS. Also, each PMOS transistor constituting the first current comparator 14-1 may have a smaller transistor size than each PMOS transistor constituting the second current comparator 14-2 so as to be operable at higher speed.

Referring back to FIG. 10, the outputs of the first and second current comparators 14-1, 14-2 are output to a timing circuit 32 through an OR gate 34, as the trigger signal SET. In the sleep period, when the sleep enable signal SLP_EN#_A becomes active (L level), the bias current source IREF of the first current comparator 14-1 having fast response and large current consumption is intercepted, so that the operation thereof is suspended. As a result, during the sleep period, only the second current comparator 14-2 of slow response performs detection by comparing the output EOUT of an error amplifier 10 with the output CS of a current sense amplifier 12.

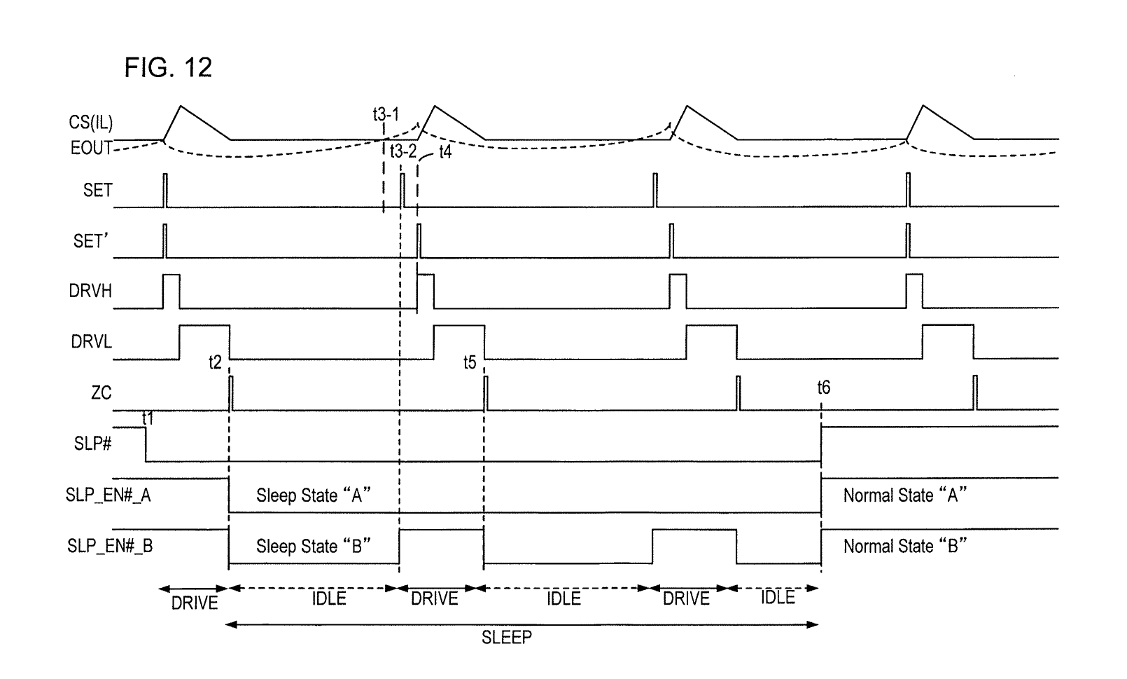

FIG. 12 is a timing chart illustrating the operation of the switching regulator depicted in FIG. 10. A point of difference from FIG. 7 is that, at the time t3 in FIG. 7, when the error amplifier output EOUT exceeds the current sense amplifier output CS, the current comparator responds fast to output the trigger signal SET substantially simultaneously, while in FIG. 12, a time t3-1 deviates from a time t3-2 because the current comparator 14-2 of slow response is operating in the sleep period SLEEP. Namely, the error amplifier output EOUT exceeds the current sense amplifier output CS at the time t3-1, and however, the current comparator 14-2 of slow response outputs the trigger signal SET at the time t3-2. Operation after the trigger signal SET is generated is identical to that depicted in FIG. 7. Therefore, a time period from the time t3-2 to a time t4 corresponds to a time to be consumed for the initiation of circuits whose operation has been suspended

According to the third embodiment described above, power efficiency at a light load is improved because the operation of the second current comparator 14-1 having fast response and large current consumption is suspended during the sleep period. Additionally, it may also be possible to operate the second current comparator 14-2 of slow response only during the sleep period SLEEP and suspend the operation thereof in the other period, so that the first current comparator 14-1 of fast response is operated.

### Fourth Embodiment

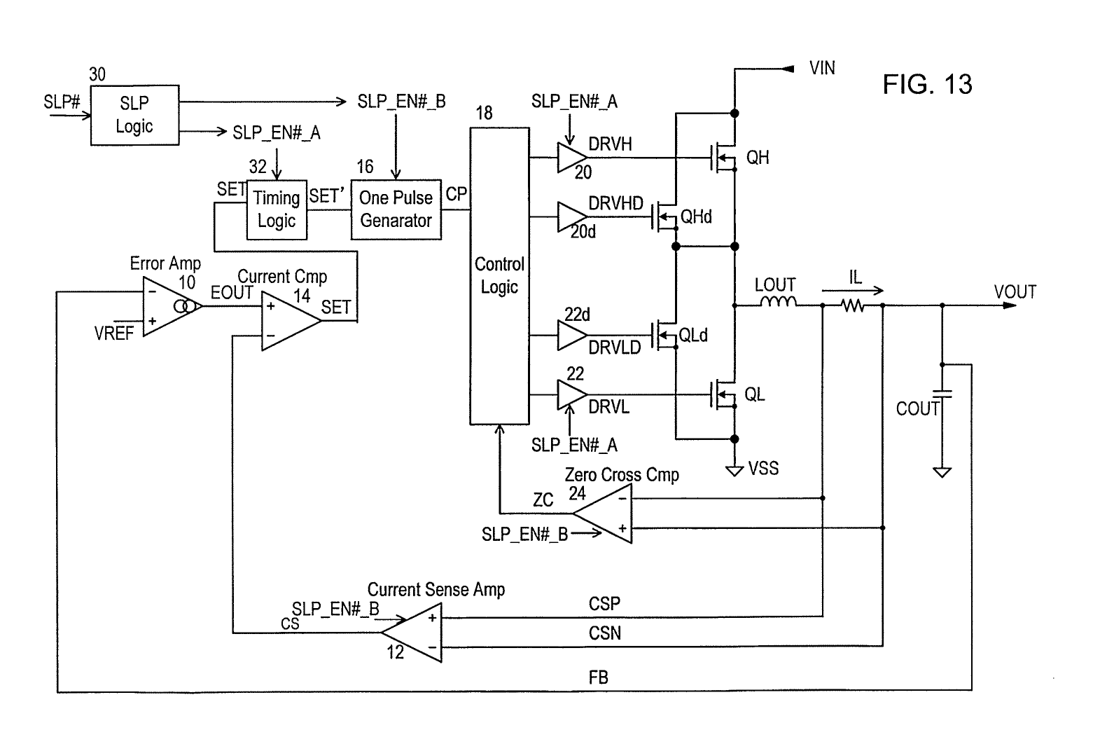

FIG. 13 is the configuration diagram of a switching regulator according to a fourth embodiment. In the configuration of this switching regulator, a point of difference from the configuration depicted in FIG. 4 is that, as output transistors, in addition to the output transistors QH, QL having wide gate widths and high drive capability, there are provided output transistors QHd, QLd having narrower gate widths and low drive capability, and also buffers 20d, 22d for outputting drive pulses DRVHD, DRVLD to the output transistors QHd, QLd having narrow gate widths. Other configuration is identical to FIG. 4.

During the sleep period, the sleep enable signal SLP_EN#_A is active (L level), and thereby the driver circuits 20, 22 suspends their operation. Thus, the drive pulses DRVH, DRVL are not output, and therefore the drive operation of the output transistors QH, QL is not performed. In place thereof, the output transistors QHd, QLd having narrow gate widths perform drive operation.

To drive the output transistors QH, QL having wide gate widths, the drive pulses DRVH, DRVL have to be supplied to the gate electrodes thereof to render the gate electrode voltages high. This requires a large amount of gate charge accompanying large power consumption, which is designated as gate charge loss. Therefore, according to the fourth embodiment, because no sudden change on the load side is guaranteed during the sleep period, drive control is performed on the output transistors QHd, QLd having narrow gate widths, while drive operation is suspended on the output transistors QH, QL having wide gate widths, and thus, power consumption is suppressed during the sleep period.

### Fifth Embodiment

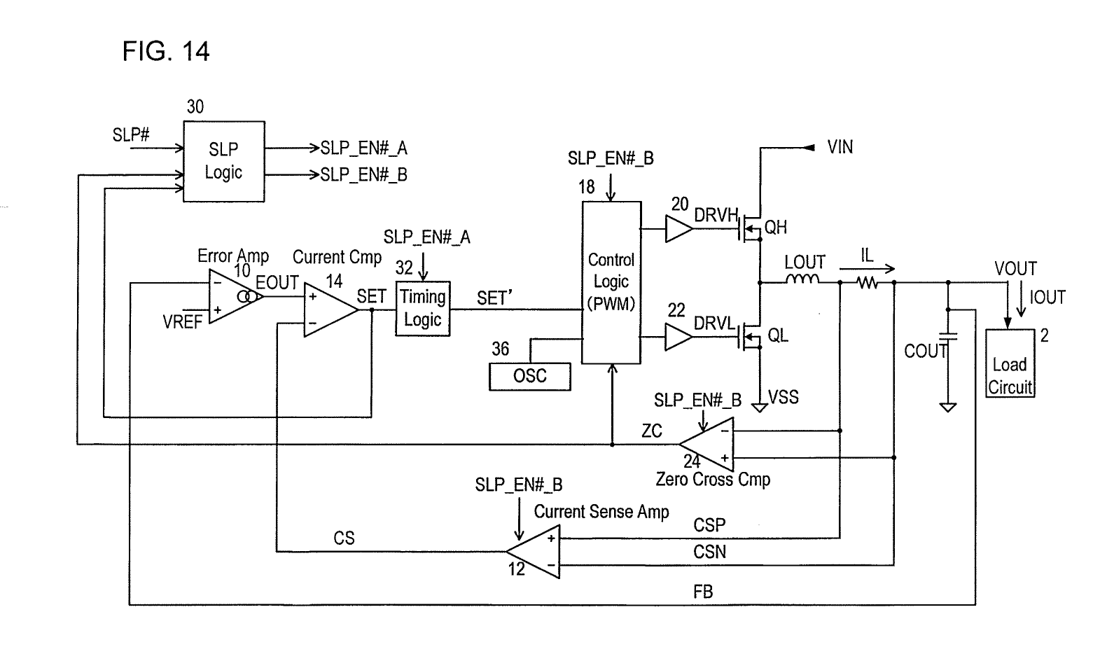

FIG. 14 is the configuration diagram of a switching regulator according to a fifth embodiment. In the configuration of this switching regulator, points of difference from FIG. 4 are that the one pulse generation circuit is not provided and, with the provision of an oscillator 36, the output of this oscillator is input to the drive control circuit 18. In FIG. 8, the switching regulator supplies current to the second power supply VOUT using pulse frequency modulation (PFM) by the drive pulse signal DRVH having the fixed pulse width. On the other hand, in the example depicted in FIG. 14, a drive control circuit 18 generates a drive pulse signal DRVH having a pulse width obtained by pulse width modulation (PWM). The drive control circuit 18 incorporates a PWM circuit which uses the oscillation clock of the oscillator 36.

As such, also in the switching regulator performing PWM control, the bias currents of a current sense amplifier 12 and a zero-cross comparator 24 are intercepted during the sleep period by the sleep enable signal SLP_EN#_B rendered active (L level), so that the operation thereof is suspended. Further, the operation of an amplifier (not illustrated) in the drive control circuit 18 to be used for PWM control is also suspended. Thus, it is possible to improve power efficiency at a light load.

In the switching regulator depicted in FIG. 14, the one pulse generation circuit 16 is not provided, and however, the drive control circuit 18 has the function of the pulse generation circuit and the drive pulse signals DRVH, DRVL correspond to the control pulses.

As having been described above, in response to a sleep signal, which guarantees no occurrence of a sudden load change, having been supplied from the load system side, the switching regulator according to the present embodiments suspend the operation of main control circuits excluding when the load circuit side needs the current supply, and maintains an operating state only in minimum circuits (the error amplifier 10 and the current comparator 14). On detection that the load circuit needs the current supply, the switching regulator supplies current by initiating circuits in suspension. Thus, it is possible to improve power efficiency in a light load condition.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A switching regulator which controls a first output transistor supplying current to an inductor and generates a second supply voltage from a first supply voltage, the switching regulator comprising:
an error amplifier configured to amplify a difference between the second supply voltage and a first reference voltage;
a current sense amplifier configured to convert an inductor current flowing through the inductor into voltage;
a current comparator configured to compare an output voltage of the error amplifier with an output voltage of the current sense amplifier, so as to output a trigger signal when the second supply voltage decreases;
a pulse generation circuit configured to generate a control pulse to drive the first output transistor in response to the trigger signal; and
a sleep control circuit configured to, during a sleep period by a sleep signal supplied from a load side to which the second supply voltage is supplied, suspend operation of the current sense amplifier or the pulse generation circuit, and to tentatively resume the suspended operation of the current sense amplifier or the pulse generation circuit in response to the trigger signal, and thereafter to suspend the operation again,
wherein in the sleep period, the pulse generation circuit generates the control pulse after a lapse of a prescribed time after the occurrence of the trigger signal.

2. The switching regulator according to claim 1,
wherein, the pulse generation circuit includes a one pulse generation circuit configured to generate a one-shot pulse having a constant pulse width as the control pulse, in response to the trigger signal.

3. The switching regulator according to claim 2,
wherein the one pulse generation circuit includes a flip-flop configured to, in response to the trigger signal, become a first state and output a forward edge of the control pulse, and a timer circuit configured to delay the forward edge, wherein the flip-flop becomes a second state by the delayed forward edge and outputs a back edge of the control pulse, and
wherein, during the sleep period, when the pulse generation circuit suspends and resumes operation, the timer circuit suspends and resumes operation respectively.

4. The switching regulator according to claim 1,
wherein the current sense amplifier becomes an operating state when a bias current is supplied, and becomes a suspended state when the bias current is intercepted or suppressed.

5. The switching regulator according to claim 1,
wherein the pulse generation circuit includes:
a drive control circuit configured to control the first transistor and a second transistor disposed between the first supply voltage and a second reference voltage between whose mutual connection node and an output terminal the inductor is provided, so that an inductor current flows through the inductor in a forward direction by rendering the first output transistor conductive, and thereafter the inductor current continuously flows through the inductor in the forward direction by rendering the first output transistor non-conductive and simultaneously the second output transistor conductive; and further comprising:
a zero-cross comparator configured to detect a changeover of the inductor current from the forward direction to a backward direction, and
wherein, in response to a detection output of the zero-cross comparator, the drive control circuit switches the second output transistor from conductive to non-conductive, and
wherein, in response to the detection output of the zero-cross comparator, the sleep control circuit suspends operation of the current sense amplifier or the pulse generation circuit from a tentative resumption state.

6. The switching regulator according to claim 1,
wherein the sleep control circuit controls such that the current comparator operates at a first response speed in other than the sleep period, and operates at a second response speed lower than the first response speed during the sleep period.

7. The switching regulator according to claim 1, further comprising:
a first small-output transistor configured to include a smaller transistor size than the first output transistor and being provided in parallel to the first output transistor; and
a drive control circuit configured to drive the first output transistor in response to the control pulse in other than the sleep period, while to suspend driving the first output transistor in response to the control pulse and to drive the first small-output transistor during the sleep period.

8. The switching regulator according to claim 1, further comprising:
an overcurrent protection circuit configured to control the inductor current not to exceed a current corresponding to the first protection voltage by rendering the first output transistor non-conductive, when an output voltage of the current sense amplifier exceeds a first protection voltage,
wherein the overcurrent protection circuit suspends operation during the sleep period.

9. The switching regulator according to claim 1, further comprising:
an overvoltage and undervoltage protection circuit configured to control the second supply voltage not to deviate from the operating voltage range by rendering the first output transistor non-conductive, when the second supply voltage deviates from an operating voltage range between a second protection voltage and a third protection voltage higher than the second protection voltage,
wherein the overvoltage and undervoltage protection circuit suspends operation during the sleep period.

10. The switching regulator according to claim 1, further comprising:
a timing circuit configured to delay the trigger signal by the prescribed time and supply a delayed trigger signal to the pulse generation circuit during the sleep period, while not to delay the trigger signal in other than the sleep period.

11. A switching regulator which controls a first output transistor and a second output transistor, disposed between a first supply voltage and a reference voltage with an inductor provided at a mutual connection node, to generate a second supply voltage from the first supply voltage, the switching regulator comprising:
an error amplifier configured to amplify a difference between the second supply voltage and a first reference voltage;
a current sense amplifier configured to convert an inductor current flowing through the inductor into voltage;
a current comparator configured to compare an output voltage of the error amplifier with an output voltage of the current sense amplifier, so as to output a trigger signal when the second supply voltage decreases;
a drive control unit configured to generate a first drive pulse to drive the first output transistor in response to the trigger signal, and to generate a second drive pulse to drive the second output transistor after driving the first output transistor; and
a sleep control circuit configured to suspend operation of the current sense amplifier or the drive control unit during a sleep period by a sleep signal supplied from a load side to which the second supply voltage is supplied, and to tentatively resume suspended operation of the current sense amplifier or the drive control unit in response to an occurrence of the trigger signal, and thereafter to suspend the operation again,
wherein in the sleep period, the drive control unit generates the first drive pulse after a lapse of a prescribed time after the occurrence of the trigger signal.

12. The switching regulator according to claim 11,
wherein the drive control unit includes:
a pulse generation circuit configured to generate a control pulse in response to the trigger signal in other than the sleep period, and to generate the control pulse after a lapse of a prescribed time after an occurrence of the trigger signal in the sleep period; and
a drive control circuit configured to generate the first and second drive pulses according to the control pulse, and
wherein, during the sleep period, the pulse generation circuit in the drive control unit suspends and resumes operation.

13. The switching regulator according to claim 11,
wherein the drive control unit, in the sleep period, generates the first drive pulse being pulse width modulated after a lapse of a prescribed time after an occurrence of the trigger signal, and in other than the sleep period, generates the pulse width modulated first drive pulse in response to the trigger signal, without the lapse of the prescribed time.
